(19) United States
(12) Patent Application Publication
(10) Pub. No.: US 2009/0004316 A1
(43) Pub. Date: Jan. 1, 2009

(54) Ice Cream Holder

(76) Inventor: Aniello Costagliola, Easton, MD (US)

Correspondence Address: Robert DeWitty, Ste. 300, 1629 K Street, Washington, DC, 20006, US

(21) Appl. No.: 11/772,087

(22) Filed: Jun. 29, 2007

(51) Int. Cl. A23G 9/28

(52) U.S. Cl. 425/221

(57) ABSTRACT

The instant invention relates to an ergonomic handle comprising a base, wherein said base comprises a convex side located opposite a concave side, a back side, a front lip, and an undercarriage located on the bottom of said handle; and an appendage extending from said base. A method of using the invention is also taught.

### BACKGROUND

In retail environments, frozen edible substances, such as ice cream, sorbet, sherbet, and the like, are usually dispersed from bulk containers using scooping devices. The devices usually consist of a handle, attached to a spherical, concave bowl. The method of scooping relies upon pressure exerted by the wrist against the frozen substance. In the event the frozen substance is extremely hard, such as when it is first brought out of the freezer, the method of scooping can create an undo and harmful amount of stress on the wrist.

Carpal tunnel syndrome is a common condition of the hand caused by swelling of the synovial membrane, tendon inflammation, and any condition that reduces the available space in the carpal tunnel. Activities that cause flexion of the wrist and fingers, such as repetitive and forceful grasping of the hands, and repetitive bending of the wrist, are common causes of the carpal tunnel syndrome. Specifically, these symptoms are caused when a dense fibrous tissue called the traverse carpal ligament forms over and compresses the median nerve. Common symptoms of the condition include pain and numbness of the hand.

In the field of scooping devices, for frozen edible foods, several inventions have attempted to address the issue of stress on the wrist;

The patent to Wanderer (U.S. Pat. No. 5,368,465) relates to an ice cream scoop designed to alleviate strain on the operators wrist, and to provide support and stability to the wrist. This is done by attaching a forearm appendage to a scoop device. While addressing the issue of carpal tunnel syndrome, it is believed that, because of the additional attachment required in the invention, such invention would be much more expensive than current scoop devices in the market. Further, the additional attachment would likely not allow the scoop to fit into standard scoop holders (as present in most retail environments).

Other patents, while not specifically drawn to scoop devices, have attempted to address carpal tunnel syndrome by designing handles. The patent to Ballone et al. (U.S. Pat. No. 4,488,460) relates to an ergonomic handle to reduce operator fatigue over extended use of the tool. The handle has an elliptical cross-section taken in the first plane passing through the center of the body and inclined with respect to the axis of the shank means. While attempting to address the issue of operator fatigue, it is believed this type of handle would not be suitable for a scooping device as the size if the handle would compromise the ability to scoop significant portions of ice cream. The patent to Dalvry (U.S. Pat. No. 5,692,265) relates to an ergonomic handle shaped to encourage a relevant working grip, thereby increasing user comfort and control.

Despite the advances in scooping devices and handles, there remains a need for a scooping device handle that is ergonomic, inexpensive to product, and suitable for fitting into standard scoop holders and retail environments.

### SUMMARY

The present invention provides a handle that allows for a reduction in pressure of the wrist of the operator.

Another object of this invention is to provide a scooping device possessing an ergonomic handle that is suitable for fitting into standard scoop holders.

Still yet, another object of this invention is to provide a scooping device that is relatively inexpensive to produce in comparison to other scoops.

The exact nature of this invention as well as other objects will be readily apparent from consideration of the specification, including the drawings. Those of skill in the art will appreciate that the invention described herein is susceptible to many modifications and variations without departing from its scope.

### BRIEF DESCRIPTION OF DRAWINGS

FIG. 1 is a bird's eye view of the present handle.

FIG. 2 is a front side view of the handle.

FIG. 3 is a rear view of the handle.

FIG. 4 shows the handle connected to a scooping device.

FIG. 5 shows the handle connected to a gardening tool.

FIG. 6 is an undercarriage view of the handle.

### DETAILED DESCRIPTION

The invention is an handle comprising a base with an appendage extending therefrom. The handle is suitable for reducing the pressure on the wrist on tool operators, thereby decreasing occurrences of carpal tunnel syndrome.

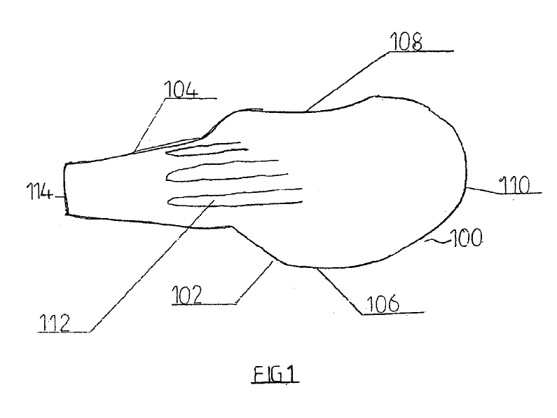

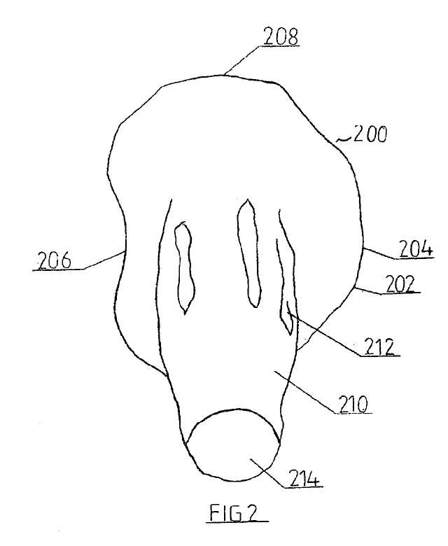

Referring to FIG. 1, a bird's eye view of the present handle (100) is given, wherein the handle (100) contains a base (102) and an appendage (104) extending therefrom.

The base (102) comprises a convex side (106), a concave side (108), a back side (110), an undercarriage (not shown), and a front lip (not shown). The base can be from 1.5 to 2 inches in width, and 2 to 5 inches in length. The base (102) may be made of materials including but not limited too, wood, plastic, polymer-based material, lightweight metal such as aluminum, or a combination of such materials.

In the base (102), the convex side (106) and the concave side (108) are located on opposite sides from each other.

The convex side (106) may extend from the back side (110) to the front lip. The most extended area of the convex side (106) may extend from 0.25 to 0.5 inches from the interior of the base (102). In one embodiment, the most extended area of the convex side (106) may be centered between the back side (110) and the front lip. In another embodiment, the most extended area of the convex side is from between 0.1 to 0.25 inches from the back side (110). The convex side (106) extends from 0.5 to 2⅜ inches in length.

The concave side (108) may extend from the back side (110) to the front lip. The most concaved section of the concave side (108) may extend from 0.1 to 0.4 inches from the outside edge of the base (102) to the interior of the base (102). In one embodiment, the most concaved area may be centered between the back side (110) and the front lip. In another embodiment, the most concaved area is located from 0.01 to 0.25 inches from the back side (110). The concave side (108) is from 1 inch to 3 inches in length.

As will be discussed later, the undercarriage is located on the bottom of the base (102). The undercarriage is positioned such that it is on a plane that is perpendicular to the planes of the convex side (106) and the concave side (108). The undercarriage is slightly concave.

The appendage (104) extending from the base (102) can be from 0.5 to 1.5 inches in length. The appendage (104) contains a front end (114) to which tools may be connected thereto. In one embodiment, the front end (114) may be flat-faceted. In other embodiments, the front end (114) may be sharpened, rounded, or other shapes suitable for accepting tools. The front end (114) may also contain attachment means including screw holes for screws, adhesive such as glue or tape, or releasable attachment means such as clips or velcro. The appendage (104) can be from 2 inches to 3 inches in diameter. In one embodiment, the appendage (104) can include grooves (112). The grooves (112) may be equidistant, or properly spaced to satisfy future users needs. The appendage (104) may be made of a material similar to the base (102), or may be made of a material different from the base (102). Suitable material for making the appendage (104) includes plastic, polymer-based material, wood, lightweight metal such as aluminum, or a combination of such materials. The appendage (104) may be positioned such that it extends from the center of the base (102). In another embodiment, the appendage (104) extends from 0.05 to 0.5 inches from the front lip of the base (102). The appendage (104) can be angled from 5° to 35° from the x-axis of the base (102). In another embodiment, the appendage (104) is angled from 20° to 30° from the x-axis of the base.

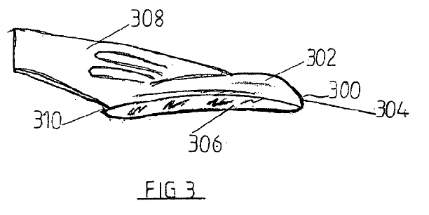

Referring to FIG. 2, a front side view of the handle (200) is shown, wherein the handle (200) contains a base (202), and an appendage (210).

The base (202) comprises a convex side (204), a concave side (206), a back side (208), a undercarriage (not shown), and a front lip (not shown). As will be discussed later, the undercarriage is slightly concave. The undercarriage is on a plane perpendicular to the planes of the convex side (204), the concave side (206), the back side (208), and the front lip.

The appendage extends from the base (202) and comprises a facet (214) and grooves (212).

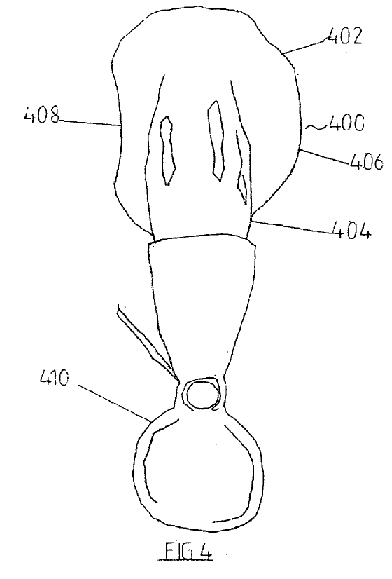

Referring to FIG. 3, a bottom side perspective of the handle (300) is shown, wherein such handle (300) comprises a base (302), and an appendage (308) extending therefrom.

The base (302) contains a back side (304) a front lip (310), an undercarriage (306), a convex side (not shown), and a concave side (not shown).

The undercarriage (306) is located on the opposite side of the appendage (308) on the handle (300) The undercarriage (306) is slightly concave, extending into the base from 0.01 to 0.1 inches. The concave area of the undercarriage (306) may extend from the back side (304) to the front lip (310). In another embodiment, the concave area may be centered between the back side (304) and front lip (310), and be situated from 0.1 to 0.5 inches from the back side (304). The plane of the undercarriage (306) is perpendicular to the planes of the concave side, convex side, back side (304), and front lip (310). The undercarriage (306) may exist as a molded part of the base (302), or may be an additional part added to the base (302). In the event the undercarriage (306) is an additional part added to the base (302), the undercarriage (306) may be made of the same material as the base (302) or may be made of a different material. Suitable materials useful for the undercarriage (306) include plastic, metal, polymer-based materials, wood, or a combination of such materials.

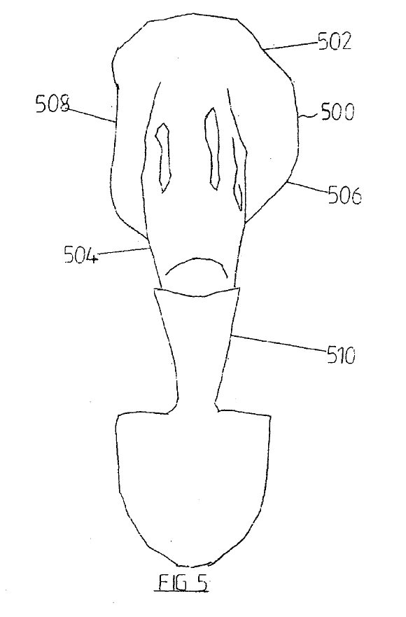

Referring to FIG. 4, an embodiment of the handle (400) is shown wherein it is connected to a tool (410). The handle (400) contains a base (402) and an appendage extending therefrom.

The base (402) of the handle (400) comprises a convex side (406), a concave side (408), a back side (409), an undercarriage (not shown), and a front lip (not shown). The undercarriage of the base (402) is concave, and on a plane perpendicular to the planes of the concave side (408), back side (409), and convex side (406).

The tool (410) in this embodiment is a scooping device, suitable for use in scooping ice cream, and other food products.

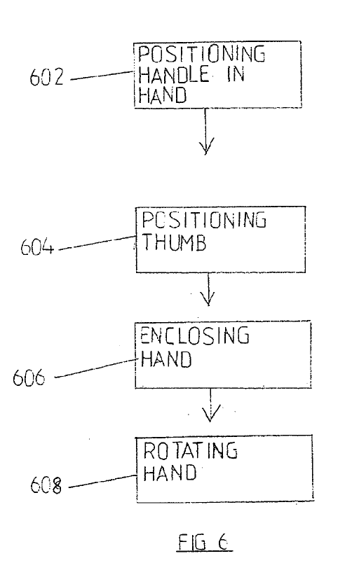

Referring to FIG. 5, an embodiment of the handle (500) is shown wherein it is used in conjunction with a gardening tool (510). The handle is comprised of a base (502), and an appendage extending therefrom (504). The base (502) is comprised of a convex side (506), a concave side (508), a back side (509), an undercarriage (not shown), and a front lip (not shown). The undercarriage of the base (502) is concave, and on a plane perpendicular to the planes of the concave side (508), back side (509), and convex side (506).

The tool (510) in this embodiment is a gardening tool, suitable for use in digging dirt, removing weeds, planting vegetation, etc.

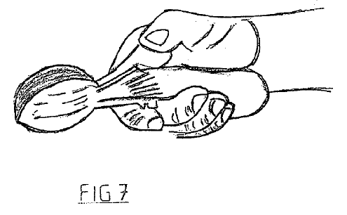

It would be obvious to one with ordinary skill in the art to substitute the above tools in FIGS. 5 and 6 with other tools for accomplishing other goals, such as spatula, wrench, hammers, etc.

Referring to FIG. 6, a method of using a handle of the present invention is given, wherein a user first positions the handle in his hand (602), the user positioning his thumb on the appendage of the handle (604), the user enclosing his hand around the handle (606), and the user rotating his hand when using the handle (608).

The user positions the handle in his hand (602) by placing the undercarriage of the base against the palm of his hand. The concave side is placed adjacent to the abductor pollicis brevis muscle of the thumb, and the convex side placed adjacent to the abductor digiti minimi muscle.

The user then positions his thumb on the appendage of the handle (602) in such a way the thumb can provide additional leverage to the scooping action of the device.

The user then encloses his hand around the handle (606) such that his fingers wrap around the base.

When using, the user rotates his hand (608) in a clockwise manner, allowing the device to perform its intended action. The design of the handle is such that stress placed on the user's wrist as a result of using the handle is dispersed throughout the entire palm, and correspondingly the muscle structure, of the hand. This allows the handle to be used for a prolonged period of time, for example 2 to 4 hours, while avoiding the risk of carpal tunnel syndrome.

Many modifications and varieties of the present invention are possible, and will be evident to those of ordinary skill in the art. For example, the handle may be constructed from a metallic material, or the handle may be constructed from a variety of synthetic plastics.

Further, the invention is suitable for use by both left-hand and right-hand grips.

Referring to FIG. 7, the completed method described in FIG. 6 is shown.

I claim:

1. An ergonomic handle comprising;
a base, wherein said base comprises a convex side located opposite a concave side, a back side, a front lip, and an undercarriage located on the bottom of said handle;
and an appendage extending from said base.

2. The ergonomic handle in claim 1, wherein said base is 1.5 to 2 inches in width, and 2 to 5 inches in length.

3. The ergonomic handle in claim 1, wherein said convex side extends from 0.25 to 0.5 inches from the interior of said base.

4. The ergonomic handle in claim 3, wherein said convex side is centered between the back side and front lip.

5. The ergonomic handle in claim 1, wherein the most concaved section of said concave side is from 0.1 to 0.4 inches from the outside edge of the base.

6. The ergonomic handle in claim 5, wherein said concave side is centered between the back side and front lip.

7. The ergonomic handle in claim 1, wherein said undercarriage is on a plane that is perpendicular to the planes of said convex side and concave side.

8. The ergonomic handle in claim 1, wherein said appendage in from 0.5 to 1.5 inches in length, and from 2 to 3 inches in diameter.

9. The ergonomic handle in claim 1, wherein said base is made of wood, plastic, polymer-based material, lightweight metal, or a combination of such materials.

10. The ergonomic handle in claim 1, wherein said appendage is made of plastic, polymer-based material, wood, lightweight metal, or a combination of such materials.

11. The ergonomic handle of claim 1, wherein said appendage is angled from 5° to 35° from the x-axis of said base.

12. The ergonomic handle in claim 1, further comprising a scooping device.

13. The ergonomic handle in claim 1, further comprising a gardening tool.

14. A method of using an ergonomic handle comprising;
a) positioning the handle such that the undercarriage is placed against the palm of the user's hand;
b) positioning the user's thumb on the appendage of the handle;
c) enclosing the user's fingers around the handle; and
d) rotating the user's hand in a clockwise manner.

15. The method of using an ergonomic handle in claim 14, wherein positioning the handle further comprises positioning the concave side adjacent to the abductor pollicis brevis muscle, and the convex side is placed adjacent to the abductor digiti minimi muscle.
